(19) United States
(12) Patent Application Publication
(10) Pub. No.: US 2004/0126539 A1
(43) Pub. Date: Jul. 1, 2004

(54) System and process for forming a product having a three-dimensional graphic

(76) Inventor: Don W. Klein, Cedarburg, WI (US)

Correspondence Address: FOLEY & LARDNER, 777 EAST WISCONSIN AVENUE, SUITE 3800, MILWAUKEE, WI, 53202-5308, US

(21) Appl. No.: 10/735,450

(22) Filed: Dec. 12, 2003

Related U.S. Application Data
(60) Provisional application No. 60/432,950, filed on Dec. 12, 2002.

(51) Int. Cl. B32B 1/00

(52) U.S. Cl. 428/141

(57) ABSTRACT

Product having a three dimensional graphic includes a transparent substrate having a rough textured portion and a first graphic component adjacent to the first substrate off the texture portion. The first graphic component has a first resolution in relationship to a texture of the textured portion so as to create a three-dimensional graphic visual effect when the first graphic component is viewed through the textured portion of the first transparent substrate.

### CROSS REFERENCE TO RELATED APPLICATIONS

The present application claims priority from co-pending U.S. Provisional Patent Application Serial No. 60/432,950, filed on Dec. 12, 2002 and having the same title herewith, the full disclosure of which is incorporated by reference.

### FIELD OF THE INVENTION

The present invention relates to systems and processes for forming products having three-dimensional graphics.

### BACKGROUND OF THE INVENTION

A variety of products today are provided with three-dimensional graphics. Three-dimensional graphics produce a visual effect of a three-dimensional object or graphic on a two-dimensional surface. Such conventionally created three-dimensional graphics are commonly referred to as holographs. Holographs are commonly found on such items as credit cards, labels and even paper currency. Although desirable for their superior appearance, such conventionally created holographs or three-dimensional graphics are currently very expensive to create and employ. As a result, the use of such holographs has been limited to date.

### BRIEF DESCRIPTION OF THE DRAWINGS

FIG. 1 is a schematic view illustrating one embodiment of a system of the present invention for creating a product having a three dimensional graphic.

FIG. 2 is a top plan view of one embodiment of a product having a three dimensional graphic.

FIG. 3 is a sectional view of the product taken along line 3-3.

FIG. 4 is a top plan view of a business card including a three dimensional graphic.

FIG. 5 is a top plan view of the business card of FIG. 4 from more of a background having various colors to illustrate transparency of the card shown.

FIG. 6 is an enlarged top perspective view of a surface of the card of FIG. 4.

FIG. 7 is an enlarged top perspective view of the surface of the card of FIG. 6 taken along a line of sight.

### DETAILED DESCRIPTION OF THE PREFERRED EMBODIMENTS

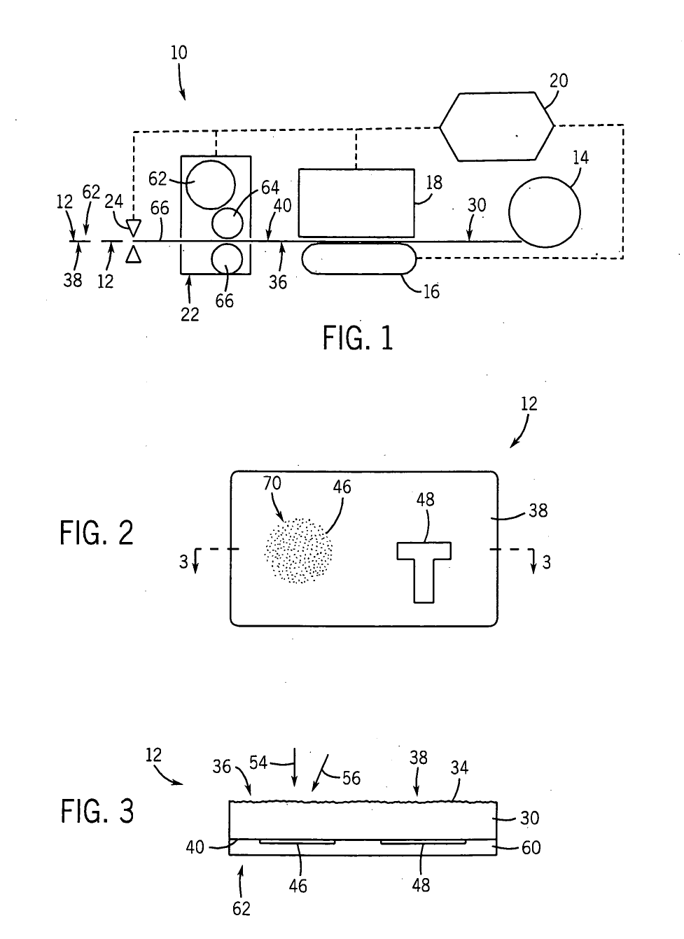

FIG. 1 is a schematic view illustrating a system 10 for creating a product having a three-dimensional graphic. The system generally includes substrate supply 14, substrate feeder 16, image forming device 18, controller 20, layer forming device 22 and separating device 24. Substrate supply 14 generally comprises a supply of a transparent or semi-transparent substrate 30 having a rough textured portion 34 (shown in FIG. 3). In the particular embodiment illustrated, supply 14 is illustrated as a roll of substrate 30. In alternative systems, supply 14 may comprise individual sheets or strips of substrate 30 or may comprise pre-cut or pre-formed sections of substrate 30.

As best shown by FIG. 3, the rough textured portion 34 extends substantially along the entirety of product 12 on a first side 36 of substrate 30. In the embodiment illustrated, side 36 of substrate 30 also forms the front or top side 38 of product 12. In alternative embodiments, rough textured portion 34 may extend along only portions of substrate 30 and along only portions of sides 36 and 38 in locations where a three-dimensional graphic visual effect is desired. Although textured portion 34 is illustrated as forming the top side 38 of product 12, in alternative embodiments, textured portion 34 may at least be partially covered by another transparent layer providing an alternative top side 38 of product 12 which may or may not be textured.

As further shown by FIG. 3, substrate 30 further includes a side 40 opposite sides 36 and 38. In the particular embodiment illustrated, side 40 has a surface configured to facilitate the printing or formation of images thereon by image forming device 18. In the embodiment where image forming device 18 prints images upon side 40, side 40 is substantially smooth.

Feeder 16 feeds substrate 30 to image forming device 18 in a timed manner. In the particular embodiment illustrated, feeder 16 comprises conventionally known belts, drums and the like. Although feeder 16 may comprise a component separate from image forming device 18, feeder 16 may also be provided as part of image forming device 18 such as where image forming device 18 and feeder 16 together are in the form of a printer. As shown by FIG. 1, image forming device 16 feeds substrate 30 to image forming device 18 such that side 40 of substrate 30 faces image forming device 18.

Image forming device 18 generally comprises a device configured to form at least one image upon side 40 of substrate 30. In the particular embodiment illustrate, image forming device 18 comprises a printer configured to print one or more images upon surface 40. Image forming device 18 is further configured to print such images in a plurality of different resolutions. Although image forming device 18 preferably comprises a printer such as ink jet, laser and the like, image forming device 18 may alternatively comprise other devices that may form images upon surface 40 such as embossing devices or devices configured to create one or more layers upon surface 40 wherein at least portions of the layers have a color to form one or more images.

Controller 20 is operably (preferably electronically) coupled to image forming device 18 and feeder 16. Controller 20 generally comprises a computer system having a processing unit or central processing unit (CPU) that executes sequences of instructions contained in a memory. More specifically, execution of the sequences of instructions causes the CPU to perform steps, which are described below. The instructions may be loaded into a random access memory (RAM) for execution by the CPU from a read-only memory (ROM), a mass storage device, or some other persistent storage. In other embodiments, hardwired circuitry may be used in place of, or in combination with, software instructions to implement the functions described. Thus, the embodiments described herein are not limited to any specific combination of hardware circuitry and software, nor to any particular source for the instructions executed by the computer system.

Computer system 20 generates control signals which are transmitted to image forming device 18. In alternative embodiments, controller 20 may be provided as part of image forming device 18. In response to the generated control signals, image forming device 18 forms a first graphic component 46 on side 40 of substrate 30 and also prints a second graphic component 48 on side 40 of substrate 30. Graphic components 46 and 48 have distinct resolutions. Graphic component 46 has a resolution chosen in relationship to the degree of roughness of textured portion 34 so as to create a three-dimensional graphic visual effect when graphic component 46 is viewed through substrate 30 and through textured portion 34. In particular, the degree of resolution of graphic component 46 is chosen such that when graphic component 46 is being viewed along different lines of sight, such as lines of sight 54 and 56, the appearance of graphic component 46 appears to change and appears to have a depth or three-dimensional characteristic. It has been discovered that by providing graphic component 46 with an appropriate resolution in relationship to the roughness, graininess or resolution of textured portion 34, viewing graphic component 46 along different lines of sight results in the bumps and depressions along portion 34 to fill in the miniscule gaps between the graphic points or dots or to alternatively blur the boundary between such graphic points or dots to create this unique three-dimensional effect. This effect is best utilized for graphic components comprising abstract designs or images. Abstract designs are generally defined as any design or graphic that does not represent a particular person, animal, structure, landscape or physical object, but is abstract in nature such as stripes, polka dots, zigzags, collages and the like. In contrast, images generally refers to a physical likeness or representation of a person, animal, landscape or thing. Although it is generally preferred to form alpha-numeric symbols at a much higher resolution to achieve sharp contrast along the borders of such alpha-numeric symbols, graphic component 46 may alternatively comprise one or more alpha-numeric symbols such as letters or numbers. In the particular embodiment illustrated, substrate 30 comprises conventionally known 15 mil clear scratch resistant vinyl supplied from such sources as Armstrong Specialties in Milwaukee, Wis. Another suitable material includes 0.020 scuff resistant rigid vinyl sold by Tektra Corporation of 16700 W. Lincoln Avenue, Dept. 77-3187, New Berlin, Wis. 53151. Graphic component 46 is printed on this substrate at a resolution of approximately 85 line screen. In alternative applications, the resolution of graphic component 46 may be varied while still achieving the three-dimensional effect depending upon the resolution or roughness of textured portion 34 and the thickness of substrate 30.

Graphic component 48 generally comprises a graphic having a much higher resolution as compared to graphic component 46. Graphic component 48 preferably has a resolution sufficiently high such that the valleys and peaks of textured portion 34 are too large relative to the even smaller voids or gaps between the graphic points or dots of component 48 so as to not fill in such gaps or points. Although viewing graphic component 48 from along different lines of sight does not result in a perceived depth or three-dimensional characteristic of component 48, graphic component 48 has much sharper and distinct boundaries. In the particular embodiment illustrated wherein graphic component 48 comprises an alpha-numeric symbol, the letter “T”, the distinct boundary is beneficial. In the particular embodiment illustrated in which substrate 30 comprises 15 mil clear scratch resistant vinyl, graphic component 48 has a resolution of approximately 175 line screen.

In the particular embodiment illustrated, graphic components 46 and 48 are each printed upon side 40 of substrate 30. Although product 12 is illustrated as including both graphic components 46 and 48, product 12 may alternatively include only component 46. Furthermore, product 12 may include a plurality of graphic components 46 or a plurality of graphic components 48 in association with one another.

Layer forming device 22 comprises a conventionally known or future developed device configured to deposit or place a layer 60 (shown in FIG. 3) upon side 30 and upon graphic components 46 and 48. As shown in FIG. 3, in the embodiment illustrated, layer 60 extends substantially across the entirety of side 40 of substrate 30 to provide product 12 with a rear or bottom side 62. Layer 60 covers and protects graphic components 46 and, 48 from removal due to abrasion or damage. In the particular embodiment illustrated, layer 60 preferably comprises a transparent material such as a polymer. In the particular embodiment, layer forming device 22 is operably coupled to controller 20 and operates in response to control signals generated by controller 20. Alternatively, layer forming device 22 may be independently controlled or operated.

In the embodiment illustrated, layer forming device 22 preferably comprises a conventionally known lamination device configured to laminate a polymeric layer against side 40 and over graphic components 46 and 48. Layer forming device 22 generally includes a lamination supply 62 and a plurality of opposing lamination rollers 64, 66 which apply and press layer 60 upon substrate 30. In alternative embodiments, the lamination device comprising layer forming device 22 may have other well known configurations. In such an embodiment, device 22 preferably heats the polymeric materials so as to fuse the layer to side 40. In alternative embodiments, device 22 may be configured to adhesively bond or weld layer 60 to substrate 30. In the embodiment illustrated, layer 60 preferably has a thickness of between about 0.3-0.5 mils. In alternative embodiments, in lieu of applying layer 60 to substantially the entirety of side 62 of product 12, device 22 may be configured to apply layer 60 to only selected portions of substrate 30 so as to cover and protect either or both of graphic components 46 or 48. In lieu of layer 60 being laminated to substrate 30, layer 60 may alternatively be coated or applied in a liquid or semi-solid form to substrate 30 over or upon components 46 and 48. Although layer forming device 22 is illustrated as being positioned in-line with image forming device 18, wherein substrate 30 comprises a continuous web or strip that passes through image forming device 18 and layer forming device 22, image forming device 22 may comprise a separate component located at a separate station. Although less desirable, in alternative embodiments, system 10 may omit layer forming device 22.

As described above, a product having a three-dimensional graphic is generally created by forming graphic component 46 upon side 40 of substrate 30 and optionally applying protective layer 60 over component 46 and securing this protective layer 60 to substrate 30. In an alternative embodiment, system 10 may form a graphic component 46 upon layer 60 and then secure layer 60 (with graphic component 46) to side 40 of substrate 30. For example, in one alternative embodiment, image forming device 18 may form graphic component 46 upon layer 60, wherein a lamination device laminates layer 60 to side 40 of substrate 30. Such lamination may be achieved by either fusing layer 60 to substrate 30 or by adhesively bonding layer 60 to substrate 30.

Separation device 24 generally comprises a device configured to separate out portions of substrate 30 or prepare or facilitate the separation of portions of substrate 30 to form products 12. In particular, substrate 30 preferably comprises an elongate band or web of material onto which graphic components 46 and 48 are formed and over which layer 60 is created. Before layer 60 is applied, separating device 24 separates portions of the band into individual products 12. In one embodiment, separation device 24 punches and severs out products 12. In another embodiment, separation device 24 scores or otherwise treats a multi-layered band 66 exiting device 22 to facilitate later manual or mechanical separation of product 12. In the particular embodiment illustrated, separation device 24 comprises a dye and a punch blade which operate in a timed manner in response to control signals received from controller 20. Although device 24 is illustrated as being in line with device 22 and device 18, device 24 may alternatively comprise a separate station. Furthermore, in those applications where substrate 30 is pre-cut or pre-formed into the desired end shape configuration, separation device 24 may be omitted.

FIG. 2 best illustrates one example of a product 12 and may be provided with a three-dimensional graphic 70 resulting from graphic component 46. In particular, FIG. 2 illustrates a card, such as a business card or credit card. The card is generally rectangular in shape and preferably has rounded corners. As a result, in those embodiments where the card is formed from a polymeric material, the card is more easily and comfortably handled. To facilitate insertion into billfolds and the like, the card preferably has a width of approximately 2 inches and a length of approximately 3.5 inches.

FIGS. 1-5 depict one example of a business card having a three-dimensional graphic. FIG. 1 depicts business card 112 made according to the process described with respect to FIGS. 1-3. For ease of description, those portions of business card 112 which correspond to portions of business card 12 are numbered similarly. FIG. 1 depicts the entire business card 112. As best shown by FIG. 1, the business card 112 generally has a uniform thickness. However, card 112 is provided with a contoured surface. In other words, the surface of card 112 has raised portions 114 and depressed portions 115. The raised portions 114 are preferably created by stamping. Alternatively, the raised and lowered portions may be created by embossing or other conventionally known or future developed techniques. In alternative embodiments, card 112 may alternatively have a varying thickness.

FIG. 2 illustrates business card 112 in front of a background having various colors to illustrate the transparency of business card 112. In the embodiment shown in the Figures, substrate 30 is a generally clear transparent polymeric material while the graphic components 46 and 48 have blue and gray colors. Graphic component 48 has a black color. In alternative embodiments, graphic components 46 and 48 may have any one of a multitude of different colors. Moreover, substrate 30 itself may be tinted so as to have one or more colors while still being transparent, i.e. permitting the transmission of light therethrough. The colors chosen for substrate 30 as well as for graphic components 46 and 48 may be chosen so as to cooperate with one another to create multi-colored effects. For example, substrate 30 may have a red tint while graphic component 46 has a blue tint, resulting in a violet effect.

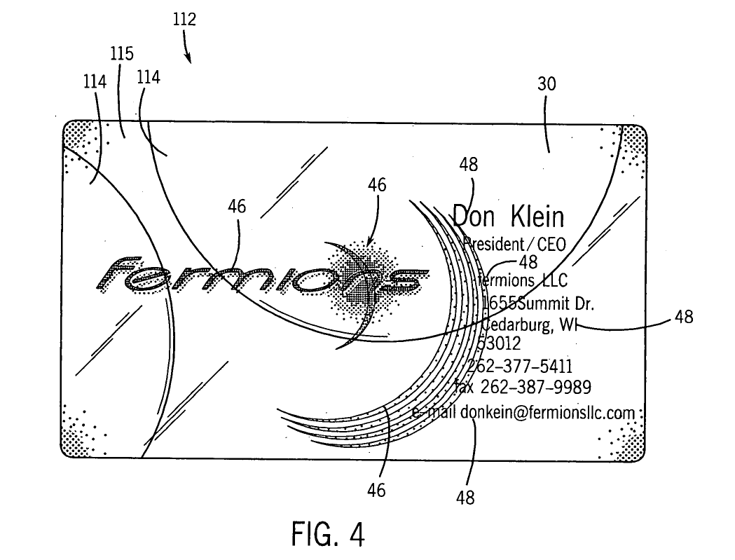

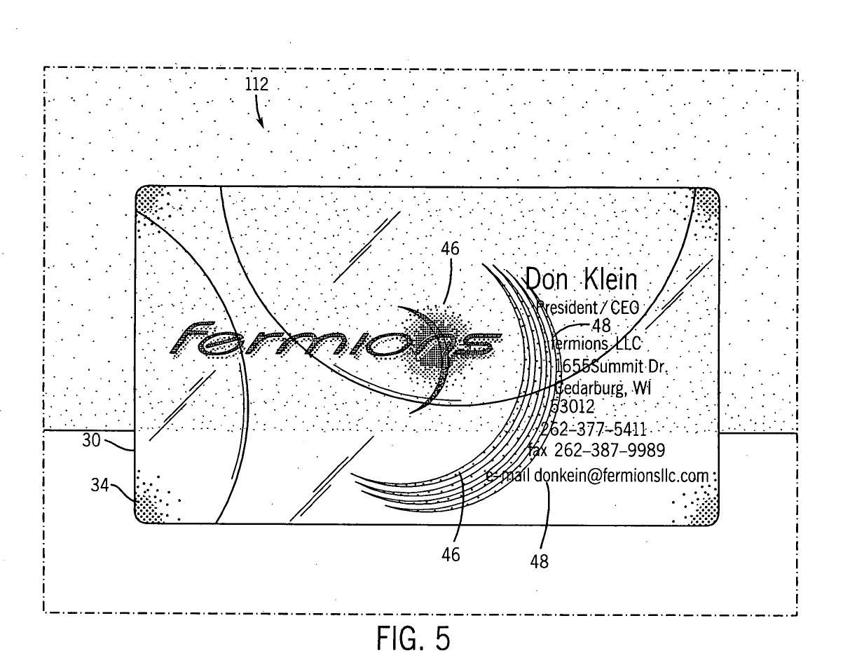

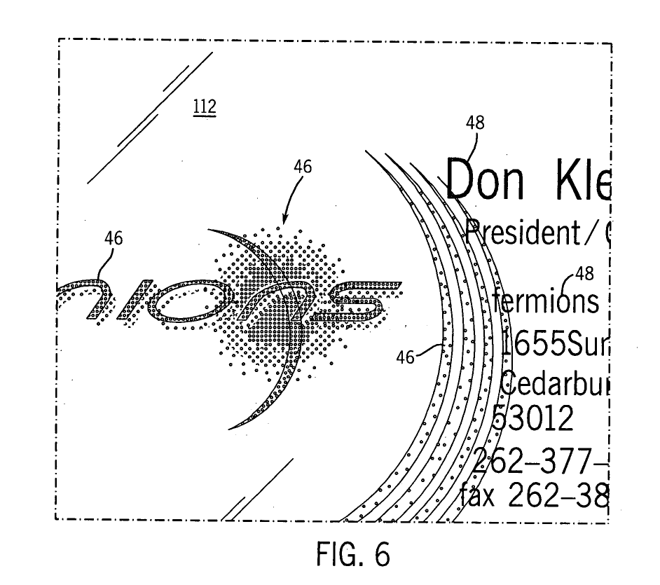

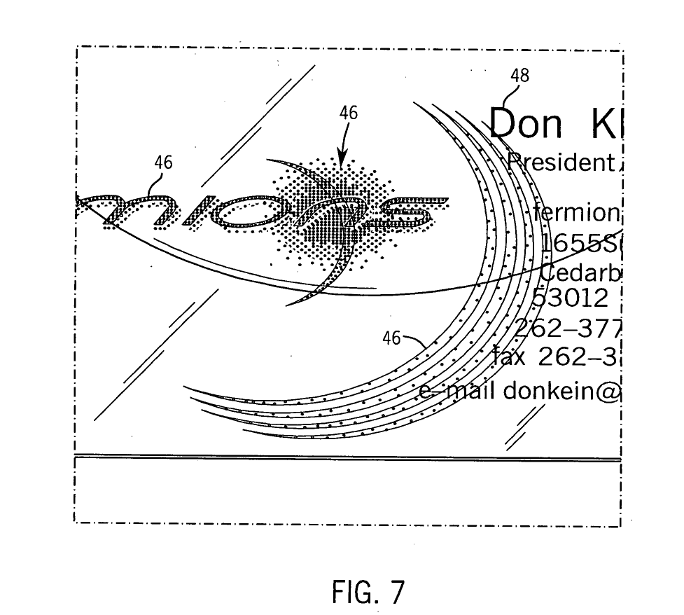

FIG. 2 further illustrates textured surface 34 of substrate 30. In particular, the rough textured surface 34 of substrate 30 is best seen in FIG. 2 by viewing that portion of card 112 in front of the white background. As shown by FIGS. 3-5, textured surface 34 has a bumpy or dimpled surface that cooperates with the particular resolution of graphic component 46 to create a three-dimensional graphic effect. FIG. 3 best depicts this phenomenon wherein the valleys and bumps of textured surface 34 fill in or blur the gaps between the color points or dots of graphic component 46. Graphic component 46 is exemplified by the bluish-gray aura about the circle on the letter “n”, the secondary offset circle adjacent the letter “o” and the letters of the word “fermions” themselves. FIGS. 4 and 5 depict graphic component 46 when viewed along distinct lines of sight.

As also shown by FIGS. 3-5, graphic component 48 has a much higher resolution such that graphic component 48 has distinct sharp boundaries to better provide detailed information on the card as represented by an individual's name, position, address and contact information.

Although the present invention has been described with reference to preferred embodiments, workers skilled in the art will recognize that changes may be made in form and detail without departing from the spirit and scope of the invention. For example, although different preferred embodiments may have been described as including one or more features providing one or-more benefits, it is contemplated that the described features may be interchanged with one another or alternatively be combined with one another in the described preferred embodiments or in other alternative embodiments. Because the technology of the present invention is relatively complex, not all changes in the technology are foreseeable. The present invention described with reference to the preferred embodiments and set forth in the above claims is manifestly intended to be as broad as possible. For example, unless specifically otherwise noted, the claims reciting a single particular element also encompass a plurality of such particular elements.

1. A method for creating a three-dimensional graphic, the method comprising:
providing a first at least partially transparent substrate having a rough textured portion; and
forming a first graphic component adjacent-the first substrate opposite the textured portion, wherein the first graphic component has a first resolution in relationship to a texture of the textured portion so as to create a three-dimensional graphic when the first graphic component is viewed through the textured portion of the substrate.

2. The method of claim 1 including forming a second graphic component adjacent the first substrate opposite the textured portion, wherein the second graphic component has a second resolution higher than the first resolution.

3. The method of claim 2, wherein the second graphic component includes alpha-numeric symbols.

4. The method of claim 3, wherein the first graphic component includes one of an image and an abstract design.

5. The method of claim 1, wherein the first substrate is clear and wherein the first graphic component has a first color.

6. The method of claim 1, wherein the first substrate has a first color and wherein the first graphic component has a second color.

7. The method of claim 1, wherein the first substrate has a uniform thickness.

8. The method of claim 1, wherein the first substrate has a contoured surface.

9. The method of claim 1, wherein the rough textured portion extends substantially along an entirety of the first substrate.

10. The method of claim 1, wherein the rough textured portion is on a first side of the first substrate.

11. The method of claim 10, wherein the first graphic component is formed on a second opposite side of the first substrate.

12. The method of claim 11, wherein the first graphic component is printed on the second side of the first substrate and wherein the second side is substantially smooth.

13. The method of claim 11, wherein the first graphic component is formed on a second substrate that is coupled to the second side of the first substrate.

14. The method of claim 13, wherein the second substrate is adhered to the second side of the first substrate.

15. The method of claim 14, wherein the second substrate is fused to the second side of the first substrate.

16. The method of claim 1, wherein the first graphic component has a resolution of 85 line screen.

17. The method of claim 1, wherein the first substrate comprises clear scratch resistant vinyl.

18. The method of claim 1 including forming a transparent layer over the first graphic component.

19. The method of claim 18 including fusing a transparent layer over the first graphic component.

20. A system for creating a three-dimensional graphic, the system comprising:
an image forming device configured to form at a first resolution and at a second resolution upon an at least partially transparent substrate; and
a controller coupled to the image forming device, wherein the controller generates a control signal and wherein the image forming device is configured to print a first graphic component upon the transparent substrate at a first resolution and a second graphic component on the at least partially transparent substrate at a second resolution.

21. The system of claim 20 including a feeder configured to feed an at least partially transparent substrate to the image forming device.

22. The system of claim 20, wherein the image forming device comprises an ink jet printer.

23. The system of claim 20 including a layer forming apparatus configured to form a transparent layer over the first and second graphic components.

24. The system of claim 23, wherein the layer forming apparatus comprises a lamination device.

25. A product having a three-dimensional graphic, the product comprising:
an at least partially transparent substrate, the substrate having a rough textured portion; and
a first graphic component adjacent the first substrate opposite the textured portion, wherein the first graphic component has a first resolution in relationship to a texture of the textured portion so as to create a three-dimensional graphic visual effect when the first graphic component is viewed through the textured portion of the first substrate.

26. The product of claim 25 including a second graphic component adjacent the first substrate opposite the textured portion, wherein the second graphic component has a second resolution higher than the first resolution.

27. The product of claim 26, wherein the second graphic component includes alpha-numeric symbols.

28. The product of claim 27, wherein the first graphic component includes one of an image and an abstract design.

29. The product of claim 25, wherein the first substrate is clear and wherein the first graphic component has a first color.

30. The product of claim 25, wherein the first substrate has a first color and wherein the first graphic component has a second color.

31. The product of claim 25, wherein the first substrate has a uniform thickness.

32. The product of claim 25, wherein the first substrate has a contoured surface.

33. The product of claim 1, wherein the rough textured portion extends substantially along an entirety of the first substrate.

34. The product of claim 25, wherein the rough textured portion is on a first side of the first substrate.

35. The product of claim 34, wherein the first graphic component is formed on a second opposite side of the first substrate.

36. The product of claim 35, wherein the first graphic component is printed on the second side of the first substrate, wherein the second side is substantially smooth.

37. The product of claim 35, wherein the first graphic component is applied to a second substrate that is coupled to the second side of the first substrate.

38. The product of claim 37, wherein the second substrate is adhered to the second side of the first substrate.

39. The product of claim 38, wherein the second substrate is fused to the second side of the first substrate.

40. The product of claim 25, wherein the first graphic component has a resolution of 85 line screen.

41. The product of claim 40, wherein the substrate comprises clear scratch resistant vinyl.

42. The product of claim 25 including a transparent layer over the first graphic component.

43. The product of claim 42, wherein the transparent layer is fused to the first substrate.

44. The product of claim 25, wherein the product comprises a business card.

45. A card comprising:
an at least partially transparent first substrate, the substrate having a rough textured portion; and
a first graphic component adjacent the first substrate opposite the textured portion, wherein the first graphic component has a first resolution in relationship to a texture of the textured portion so as to create a three-dimensional graphic visual effect when the first graphic component is viewed through the textured portion of the first substrate.

46. The card of claim 45 including a second graphic component adjacent the first substrate opposite the textured portion, wherein the second graphic component has a second resolution higher than the first resolution.

47. The card of claim 46, wherein the second graphic component includes alpha-numeric symbols.

48. The card of claim 47, wherein the first graphic component includes one of an image and an abstract design.

49. The card of claim 45, wherein the first substrate is clear and wherein the first graphic component has a first color.

50. The card of claim 45, wherein the first substrate has a first color and wherein the first graphic component has a second color.

51. The card of claim 45, wherein the first substrate has a uniform thickness.

52. The card of claim 45, wherein the first substrate has a contoured surface.

53. The card of claim 1, wherein the rough textured portion extends substantially along an entirety of the first substrate.

54. The card of claim 45, wherein the rough textured portion is on a first side of the first substrate.

55. The card of claim 45, wherein the first graphic component is formed on a second opposite side of the first substrate.

56. The card of claim 55, wherein the first graphic component is printed on the second side of the first substrate, wherein the second side is substantially smooth.

57. The card of claim 55, wherein the first graphic component is applied to a second substrate that is coupled to the second side of the first substrate.

58. The card of claim 57, wherein the second substrate is adhered to the second side of the first substrate.

59. The card of claim 57, wherein the second substrate is fused to the second side of the first substrate.

60. The card of claim 45, wherein the first graphic component has a resolution of 85 line screen.

61. The card of claim 60, wherein the substrate comprises clear scratch resistant vinyl.

62. The card of claim 45 including a transparent layer over the first graphic component.

63. The card of claim 62, wherein the transparent layer is fused to the first substrate.

64. The card of claim 45, wherein the card comprises a business card.

65. The card of claim 45, wherein the substrate has a width of about 2 inches and a length of about 3.5 inches.

66. The card of claim 64, wherein the business card has a thickness of less than about 5 mils.

67. The card of claim 45, wherein the card is generally rectangular and wherein the card has rounded corners.
